(19) United States
(12) Patent Application Publication
(10) Pub. No.: US 2025/0109223 A1
(43) Pub. Date: Apr. 3, 2025

(54) METHOD FOR PREPARING A ZIEGLER-NATTA CATALYST SYSTEM WITH IMPROVED PERFORMANCE IN PROPYLENE POLYMERIZATION

(71) Applicant: Formosa Plastics Corporation, U.S.A., Livingston Township, NJ (US)

(72) Inventors: Lei ZHANG, Port Lavaca, TX (US); Gapgoung Kong, Sugarland, TX (US); Cyrus C.Y. Lee, Victoria, TX (US); Guangxue Xu, Port Lavaca, TX (US)

(21) Appl. No.: 18/477,185

(22) Filed: Sep. 28, 2023

(51) Int. Cl. C08F 110/06; C08F 4/659

(52) U.S. Cl. CPC C08F 110/06; C08F 4/65912

(57) ABSTRACT

A method for preparing a Ziegler-Natta catalyst system, especially a phthalate-free catalyst system, with improved performance in propylene polymerization is provided. It is found that catalyst performance, especially catalyst activity and hydrogen response, is significantly improved when a propylene-based pre-polymer is prepared in the presence of a vinyldisilane compound and then used in propylene polymerization.

### BACKGROUND

The present invention relates to a method for preparing a Ziegler-Natta catalyst system, especially a phthalate-free catalyst system, with improved performance in propylene polymerization, e.g., higher polymerization activity and better hydrogen response.

Ziegler-Natta catalyst systems for olefin polymerization are well known in the art. Commonly, these systems are composed of a solid Ziegler-Natta catalyst component and a co-catalyst component, usually an organoaluminum compound. To increase the activity and sterospecificity of the catalyst system for the polymerization of α-olefins, electron donating compounds have been widely used (1) as an internal electron donor in the solid Ziegler-Natta catalyst component, and/or (2) as an external electron donor to be used in conjunction with the solid Ziegler-Natta catalyst component and the co-catalyst component.

In the utilization of Ziegler-Natta type catalysts for polymerizations involving propylene or other olefins for which isotacticity is a possibility, it may be desirable to utilize an external electron donor, which may or may not be in addition to the use of an internal electron donor. Acceptable external electron donors include organic compounds containing O, Si, N, S, and/or P. Preferred external electron donors are organosilicon compounds containing Si—O—C and/or Si—N—C bonds, having silicon as the central atom.

Common internal electron donor compounds, which are incorporated in the solid Ziegler-Natta catalyst component during preparation of such component, are well known in the art and include ethers, esters, ketones, amines, alcohols, heterocyclic organic compounds, phenols, phosphines, and silanes. It is also well known in the art that polymerization activity, as well as stereoregularity, molecular weight, and molecular weight distribution of the resulting polymer depend on the molecular structure of the internal electron donor employed.

Most commercial propylene polymerization catalysts currently used employ alkyl phthalate esters as an internal electron donor. However, certain environmental issues have been recently raised concerning the continued use of phthalate derivatives in human contact applications. The health concerns from phthalate exposure are driving the art to find phthalate substitute, or phthalate-free catalyst composition. For example, malonic esters, succinic esters, or 1,3-diether compounds have been employed as an internal donor for phthalate-free catalyst component for propylene polymerization.

However, such a phthalate-free catalyst system normally doesn't exhibit a polymerization performance comparable to that of a phthalate-based catalyst system. In particular, a phthalate-free catalyst component tends to demonstrate low polymerization activity and/or low stereo-selectivity in propylene polymerization.

U.S. Pat. Nos. 7,858,716; 8,232,358; and 10,526,427 teach a method to improve the catalyst performance in gas phase polymerization by treatment of phthalate-based catalyst with SiCl₄ and a vinylsilane compound followed by propylene pre-polymerization. However, the effect of such a treatment on phthalate-free catalyst was not considered.

U.S. Pat. Nos. 10,392,453 and 10,472,436 teach a method to improve the propylene polymerization productivity of phthalate-free catalysts by treatment of catalyst with a vinylsilane compound. Due to the volatility of such a vinylsilane compound, use of pure vinylsilane had to be mixed with dry catalyst powder in a special device.

As such, there is still a need and desire to develop a phthalate-free catalyst system providing further improved polymerization performance for propylene polymerization.

### SUMMARY OF THE INVENTION

The present invention provides a method for preparing a Ziegler-Natta catalyst system, especially a phthalate-free catalyst system, with improved performance in propylene polymerization, e.g., higher polymerization activity and better hydrogen response.

The present inventors have found that catalyst performance, especially catalyst activity and hydrogen response, was significantly improved when a propylene-based pre-polymer was prepared and used in propylene polymerization. Such a propylene-based pre-polymer was prepared in the following steps:
(1) Preparing a bare catalyst (C) by contacting a solid catalyst component (C1) containing magnesium, titanium and a halogen as essential components, a vinyldisilane compound (C2), optionally an organoaluminum compound (C3), and optionally an organosilicon compound (C4) containing Si—O—C and/or Si—N—C bonds, wherein the vinyldisilane compound (C2) is represented by Formula I:

$${( {CH}_{2} = CH - )}_{m} {( {R}^{1} )}_{n} {( {R}^{2} O - )}_{k} Si - {Si ( - CH = {CH}_{2} )}_{x} {( {R}^{3} )}_{y} {( - {OR}^{4} )}_{z} \qquad ( Formula I )$$

In Formula I, R¹, R², R³ and R⁴ represent a hydrocarbon group or a heteroatom-containing hydrocarbon group, provided that 1≤m≤3, 0≤n≤2, 0≤k≤2, 0≤x≤3, 0≤y≤3, 0≤z≤3, m+n+k=3 and x+y+z=3. In Formula I, m and x represent the number of a vinyl group bonded to different Si atoms. Preferably m is 1 and x is also 1. In the case when n>1, R¹'s can be the same or different. In the case when y>1, R³'s can be the same or different. In the case when k>1, (R²O—)'s can be the same or different. In the case when z>1, (R⁴O—)'s can be the same or different; and

(2) Preparing a propylene-based pre-polymer (P) by contacting the bare catalyst (C) with propylene.

### DESCRIPTION OF PREFERRED EMBODIMENTS

The present invention is characterized by using a bare catalyst (C), which is prepared by contacting a solid catalyst component (C1) containing magnesium, titanium and a halogen as essential components; a vinyldisilane compound (C2); optionally an organoaluminum compound (C3); and optionally an organosilicon compound (C4) containing Si—O—C and/or Si—N—C bonds, as a catalyst for propylene pre-polymerization and then propylene polymerization.

Preferred solid Ziegler-Natta type catalyst component (C1) includes solid catalyst components comprising a titanium compound having at least a Ti-halogen bond and an internal electron donor compounds supported on an anhydrous magnesium-dihalide support. Such preferred solid Ziegler-Natta type catalyst component (C1) includes solid catalyst components comprising a titanium tetrahalide. A preferred titanium tetrahalide is TiCl₄. Alkoxy halides may also be used solid Ziegler-Natta type catalyst component (C1).

Acceptable anhydrous magnesium dihalides forming the support of the solid Ziegler-Natta type catalyst component (C1) are the magnesium dihalides in active form that are well known in the art. Such magnesium dihalides may be pre-activated, may be activated in-situ during the titanation, or may be formed in-situ from a magnesium compound that is capable of forming magnesium dihalide when treated with a suitable halogen-containing transition metal compound, and then activated. Preferred magnesium dihalides are magnesium dichloride and magnesium dibromide. The water content of the dihalides is generally less than 1% by weight.

The solid Ziegler-Natta type catalyst component (C1) may be made by various methods. One such method consists of co-grinding the magnesium dihalide and the internal electron donor compounds until the product shows a surface area higher than 20 m²/g and thereafter reacting the ground product with the Ti compound. Other methods of preparing solid Ziegler-Natta type catalyst component (C1) are disclosed in U.S. Pat. Nos. 4,220,554; 4,294,721; 4,315,835; 4,330,649; 4,439,540; 4,816,433; and 4,978,648; each of which are incorporated by reference herein in its entirety.

In a typical solid Ziegler-Natta type catalyst component (C1), the molar ratio between the magnesium dihalide and the halogenated titanium compound is in the range between about 1 and about 500, the molar ratio between said halogenated titanium compound and mixture of internal electron donor compounds is in the range between about 0.1 and about 50.

Acceptable vinyldisilane compound (C2) is represented by Formula I:

$${( {CH}_{2} = CH - )}_{m} {( {R}^{1} )}_{n} {( {R}^{2} O - )}_{k} Si - {Si ( - CH = {CH}_{2} )}_{x} {( {R}^{3} )}_{y} {( - {OR}^{4} )}_{z} \qquad ( Formula I )$$

wherein R¹, R², R³ and R⁴ represent a hydrocarbon group or a heteroatom-containing hydrocarbon group, provided that 1≤m≤3, 0≤n≤2, 0≤k≤2, 0≤x≤3, 0≤y≤3, 0≤z≤3, m+n+k=3 and x+y+z=3. In Formula I, m and x represent the number of a vinyl group bonded to different Si atoms. Preferably m is 1 and x is also 1. In Formula I, R¹ and R³ are preferably a C1 to C20 hydrocarbon group, and more preferably a methyl group, an ethyl group, a cyclohexyl group and a phenyl group. “n” and “y” represent the number of R¹ and R³, respectively. Preferably n is 2 and y is also 2. In the case when n>1, R¹'s can be the same or different. In the case when y>1, R³'s can be the same or different. In Formula I, R² and R⁴ are preferably a C1 to C20 hydrocarbon group, and more preferably a methyl group and an ethyl group. “k” and “z” represent the number of —OR² and —OR⁴, respectively. Preferably k is 0 and z is also 0. In the case when k>1, (R²O—)'s can be the same or different. In the case when z>1, (R⁴O—)'s can be the same or different.

Preferred organoaluminum compound (C3) includes aluminum alkyl compounds. Acceptable aluminum alkyl compounds include aluminum trialkyls, such as aluminum triethyl, aluminum triisobutyl, and aluminum triisopropyl. Other acceptable aluminum alkyl compounds include aluminum-dialkyl hydrides, such as aluminum-diethyl hydrides. Other acceptable organoaluminum compound (C3) includes compounds containing two or more aluminum atoms linked to each other through hetero-atoms, such as: (C₂H₅)₂Al—O—Al(C₂H₅)₂; (C₂H₅)₂Al—N(C₆H₅)—Al(C₂H₅)₂; and (C₂H₅)₂Al—O—SO₂—O—Al(C₂H₅)₂.

Preferred organosilicon compound (C4) is organosilicon compounds containing Si—O—C and/or Si—N—C bonds. Preferred examples of such organosilicon compounds are trimethylmethoxysilane, diphenyldimethoxysilane, cyclohexylmethyldimethoxysilane, diisopropyldimethoxysilane, dicyclopentyldimethoxysilane, isobutyltriethoxysilane, vinyltrimethoxysilane, dicyclohexyldimethoxysilane, 3-tert-Butyl-2-isobutyl-2methoxy-[1,3,2]oxazasilolidine, 3-tert-Butyl-2-cyclopentyl-2-methoxy-[1,3,2]oxazasilolidine, 2-Bicyclo[2.2.1]hept-5-en-2-yl-3-tert-butyl-2-methoxy-[1,3,2]oxazasilolidine, 3-tert-Butyl-2,2-diethoxy-[1,3,2]oxazasilolidine, 4,9-Di-tert-butyl-1,6-dioxa-4,9-diaza-5-sila-spiro[4.4]nonane, bis(perhydroisoquinolino)dimethoxysilane, etc. Mixtures of organosilicon compounds may also be used.

The bare catalyst (C) in the present invention is prepared by contacting a solid catalyst component (C1) containing magnesium, titanium and a halogen as essential components; a vinyldisilane compound (C2); optionally an organoaluminum compound (C3); and optionally an organosilicon compound (C4) containing Si—O—C and/or Si—N—C bonds.

Acceptable contact methods include a mechanical method by a rotation ball mill or a vibration mill and a method for mixing by agitation in the presence of an inert solvent. The preferred contact method is mixing by agitation in the presence of an inert solvent. The preferred contact temperature is in the range of about −20° C. to about 100° C., more preferably in the range of about 10° C. to about 60° C.

The preferred molar ratio of vinyldisilane component (C2) to titanium in component (C1) is in the range of about 0.01 to about 100, more preferably in the range of about 1.0 to about 10.

When an organoaluminum compound (C3) is used, the preferred molar ratio of component (C3) to titanium in component (C1) is in the range of about 0 to about 1000, more preferably in the range of about 1.0 to about 500.

When an organosilicon compound (C4) containing Si—O—C and/or Si—N—C bonds is used, the preferred molar ratio of component (C4) to titanium in component (C1) is in the range of about 0 to about 1000, more preferably in the range of about 1.0 to about 100.

Contacting the bare catalyst (C) with propylene to form a propylene-based pre-polymer (P) may be carried out with or without isolating the solid bare catalyst (C) from the reaction mixture of the bare catalyst (C) formation. Preferably, the solid bare catalyst (C) is not isolated from the reaction mixture and contacted directly with propylene to form the propylene-based pre-polymer.

The amount of the propylene-based pre-polymer is preferably in the range of about 0.1 g to about 50 g, more preferably in the range of about 1.0 g to about 10 g, based on 1.0 g of the solid catalyst component (C1). The preferred pre-polymerization temperature is in the range of about −50° C. to about 100° C., more preferably in the range of about −20° C. to about 50° C. The pre-polymerization is preferably carried out under agitation and an inert solvent may be present.

If an organoaluminum compound (C3) is not used in the bare catalyst (C) formation reaction, it is required in the propylene pre-polymerization step. In this case, the preferred molar ratio of organoaluminum component (C3) to titanium in component (C1) is in the range of about 1 to about 1000, more preferably in the range of about 10 to about 500.

An organosilicon compound (C4) containing Si—O—C and/or Si—N—C bonds may be used in the pre-polymerization step. The preferred molar ratio of component (C4) to titanium in component (C1) is in the range of about 0.1 to about 1000, more preferably in the range of about 1 to about 100.

After pre-polymerization, the pre-polymer may be washed with an inert solvent such as hexane, heptane or the like. The prepared pre-polymer may be used without further treatment in the olefin polymerization step. If necessary, it may also be dried.

The olefin polymerization processes that may be used in accordance with the present invention are not generally limited. The olefin monomer and/or co-monomer may be added prior to, with, or after the addition of the pre-polymer (P) to the polymerization reactor. It is preferred to add the olefin monomer and/or co-monomer after the addition of the pre-polymer (P).

The molecular weight of the polymers may be controlled in a known manner, preferably by using hydrogen. With the catalysts produced according to the present invention, molecular weight may be suitably controlled with hydrogen when the polymerization is carried out at relatively low temperatures, e.g., from about 30° C. to about 105° C. This control of molecular weight may be evidenced by a measurable positive change of the Melt Flow Rate.

The polymerization reactions may be carried out in slurry, liquid or gas phase processes, or in a combination of liquid and gas phase processes using separate reactors, all of which may be done either by batch or continuously. The polyolefin may be directly obtained from gas phase process, or obtained by isolation and recovery of solvent from the slurry process, according to conventionally known methods.

There are no particular restrictions on the polymerization conditions for production of polyolefins by the method of this invention, such as the polymerization temperature, polymerization time, polymerization pressure, monomer concentration, etc. The polymerization temperature is generally from about 40° C. to about 90° C. and the polymerization pressure is generally about 1 atmosphere or higher.

The Ziegler-Natta type catalyst systems of the present invention are useful in the polymerization of olefins, including but not limited to homo-polymerization and copolymerization of alpha olefins. Suitable α-olefins that may be used in a polymerization process in accordance with the present invention include olefins of the general formula CH₂═CHR, where R is H or C₁₋₁₀ straight or branched alkyl, such as ethylene, propylene, butene-1, pentene-1, 4-methylpentene-1 and octene-1. While the Ziegler-Natta type catalyst systems of the present invention may be employed in processes in which ethylene is polymerized, it is more desirable to employ the Ziegler-Natta type catalyst systems of the present invention in processes in which polypropylene or higher olefins are polymerized. Processes involving the homo-polymerization or copolymerization of propylene are preferred.

### EXAMPLES

In order to provide a better understanding of the foregoing, the following non-limiting examples are offered. Although the examples may be directed to specific embodiments, they are not to be viewed as limiting the invention in any specific respect. The catalyst activity values are based upon grams of polymer produced per gram of solid catalyst component (C1) used.

The following analytical methods are used to characterize the polymer.

Heptane Insolubles (HI %): The weight percent (wt %) of residuals of polypropylene sample after extracted with boiling heptane for 8 hours.

Melt Flow rate (MFR): ASTM D-1238, determined at 230° C. under the load of 2.16 kg.

Anhydrous n-heptane (99%) and triethylaluminum (93%) were purchased from Sigma-Aldrich Co. of Milwaukee, WI, USA. 1,2-Divinyltetramethyldisilane and diisopropyldimethoxysilane (P-donor) were purchased from Gelest, Inc. of Morrisville, PA, USA. Phthalate-free catalyst TFC and phthalate-based catalyst THC-C were purchased as dry powders from Toho Titanium Co., Japan.

Unless otherwise indicated, all reactions were conducted under an inert atmosphere.

### Example 1

### (A) Preparation of Propylene-Based Pre-Polymer (P-1)

Into a dry 2-liter bench scale reactor under the protection of nitrogen atmosphere, 500 ml of purified heptane was charged, followed by 15 ml of triethylalumium (0.58 M in hexanes) and 5 ml of diisopropyl(dimethoxy)silane (P-donor) (0.5 M in heptane). The reaction mixture was stirred for 10 minutes at room temperature, and then 5 g of TFC catalyst powder and 0.68 grams of pure 1,2-divinyltetramethyldisilane were added to the reactor. After stirring at 30° C. for 2 hours, a slurry containing a solid component (C-1) was obtained.

After the slurry was cooled to 10° C., 10 g of propylene gas was fed over a period of 15 minutes, and then the reaction was continued for 10 minutes. The solid component was washed with pure heptane and dried under vacuum to obtain propylene pre-polymer (P-1).

### (B) Propylene Slurry Polymerization

Propylene polymerization was conducted in another bench scale 2-liter reactor per the following procedure.

The reactor was first preheated to at least 100° C. with a nitrogen purge to remove residual moisture and oxygen. The reactor was thereafter cooled to 50° C. Under nitrogen, 1 liter dry heptane was introduced into the reactor. When reactor temperature was about 50° C., 4.3 ml of triethylaluminum (0.58M, in hexanes), 0.4 ml of diisopropyl(dimethoxy)silane (P-donor) (0.5 M in heptane), and then 60 mg of the propylene pre-polymer (P-1) prepared above were added to the reactor. The temperature of the reactor was heated to 50° C. and 8 mmol or 16 mmol of hydrogen in a 150 ml vessel was flushed into the reactor with propylene.

The reactor temperature was then raised to 70° C. The total reactor pressure was raised to and controlled at 90 psig by continually introducing propylene into the reactor and the polymerization was allowed to proceed for 1 hour. After polymerization, the reactor was vented to reduce the pressure to 0 psig and the reactor temperature was cooled to 50° C.

The reactor was then opened. 500 ml methanol was added to the reactor and the resulting mixture was stirred for 5 minutes then filtered to obtain the polymer product. The obtained polymer was vacuum dried at 80° C. for 6 hours. The polymer was evaluated for melt flow rate (MFR) and heptane insoluble (HI %). The activity of catalyst was also measured. The results are shown in TABLE 1.

### Example 2

A propylene pre-polymer (P-2) was prepared in the same manner as in Example 1, except that 1.02 grams of pure 1,2-divinyltetramethyldisilane was used instead of 0.68 grams of pure 1,2-divinyltetramethyldisilane. Propylene polymerization was carried out in the same manner as described in Example 1, except that propylene pre-polymer (P-2) was charged instead of propylene pre-polymer (P-1). The results are summarized in TABLE 1.

### Comparative Example 1

### (A) Preparation of Propylene-Based Pre-Polymer (CP-1)

Into a dry 2-liter bench scale reactor under the protection of nitrogen atmosphere, 500 ml of purified heptane was charged, followed by 15 ml of triethylalumium (0.58 M in hexanes) and 5 ml of diisopropyl(dimethoxy)silane (P-donor) (0.5 M in heptane). The reaction mixture was cooled to 10° C. and stirred for 10 minutes, and then 5 g of TFC catalyst powder was added to the reactor. After the slurry was cooled to 10° C., 10 g of propylene gas was fed over a period of 15 minutes, and then the reaction was continued for 10 minutes. The solid component was washed with pure heptane and dried under vacuum to obtain propylene pre-polymer (CP-1).

### (B) Propylene Slurry Polymerization

Propylene polymerization was carried out in the same manner as described in Example 1, except that propylene pre-polymer (CP-1) was charged instead of propylene pre-polymer (P-1). The results are summarized in TABLE 1.

### Example 3

A propylene pre-polymer (P-3) was prepared in the same manner as in Example 1, except that 5 g of THC-C catalyst powder was used instead of 5 g of TFC catalyst powder. Propylene polymerization was carried out in the same manner as described in Example 1, except that propylene pre-polymer (P-3) was charged instead of propylene pre-polymer (P-1) and 12 mmol or 24 mmol of hydrogen in a 150 ml vessel was used instead of 8 mmol or 16 mmol of hydrogen. The results are summarized in TABLE 1.

### Comparative Example 2

### (A) Preparation of Propylene-Based Pre-Polymer (CP-2)

Into a dry 2-liter bench scale reactor under the protection of nitrogen atmosphere, 500 ml of purified heptane was charged, followed by 15 ml of triethylalumium (0.58 M in hexanes) and 5 ml of diisopropyl(dimethoxy)silane (P-donor) (0.5 M in heptane). The reaction mixture was cooled to 10° C. and stirred for 10 minutes, and then 5 g of THC-C catalyst powder was added to the reactor. After the slurry was cooled to 10° C., 10 g of propylene gas was fed over a period of 15 minutes, and then the reaction was continued for 10 minutes. The solid component was washed with pure heptane and dried under vacuum to obtain propylene pre-polymer (CP-2).

### (B) Propylene Slurry Polymerization

Propylene polymerization was carried out in the same manner as described in Example 1, except that propylene pre-polymer (CP-2) was charged instead of propylene pre-polymer (P-1) and 12 mmol or 24 mmol of hydrogen in a 150 ml vessel was used instead of 8 mmol or 16 mmol of hydrogen. The results are summarized in TABLE 1.

TABLE 1

| | Solid | | | | | | |
|---|---|---|---|---|---|---|---|
| | Catalyst | | (C2)/Ti | | | | |
| | Component | Vinyldisilane | in (C1) | Hydrogen | Activity | MFR | |
| | (C1) | (C2) | (mol/mol) | (mmol) | (g/g · h) | (g/10 min) | HI % |
| Example 1 | TFC | 1,2- | 2 | 8 | 8810 | 12 | 99.4 |
| | | divinyltetra- | | 16 | 9795 | 35 | 99.1 |
| | | methyldisilane | | | | | |
| Example 2 | TFC | 1,2- | 3 | 8 | 8815 | 12 | 99.5 |
| | | divinyltetra- | | 16 | 9510 | 35 | 99.2 |
| | | methyldisilane | | | | | |
| Comparative | TFC | none | 0 | 8 | 5285 | 10 | 99.6 |
| Example 1 | | | | 16 | 5390 | 31 | 99.3 |
| Example 3 | THC-C | 1,2- | 2 | 12 | 8355 | 12 | 99.0 |
| | | divinyltetra- | | 24 | 8540 | 40 | 98.6 |
| | | methyldisilane | | | | | |
| Comparative | THC-C | none | 0 | 12 | 7840 | 10 | 99.1 |
| Example 2 | | | | 24 | 7170 | 28 | 98.7 |

As is clearly shown in Table 1, in comparative study between Examples 1 & 2 and Comparative Example 1, the application of vinyldisilane (C2) during propylene-based pre-polymer preparation has significantly improved the catalyst activity of phthalate-free catalyst TFC. In the absence of vinyldisilane (C2) as in Comparative Example 1, catalyst activity in propylene homo-polymerization is 5390 g/g·h when 16 mmol of hydrogen is charged into the 2 L slurry polymerization reactor. Under the similar polymerization conditions, the application of vinyldisilane (C2) has increased the catalyst activity to 9795 g/g·h as shown in Example 1. Polymer MFR is also higher in Examples 1 & 2 than that in Comparative Example 1, indicating the application of vinyldisilane (C2) increases the hydrogen response of phthalate-free catalyst TFC.

The same trend has also been observed in the case of phthalate-based catalyst THC-C. As shown in comparative study between Example 3 and Comparative Example 2, application of vinyldisilane (C2) not only improves the catalyst activity, but also increases the hydrogen response of catalyst THF-C.

As such, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Whenever a numerical range with a lower limit and an upper limit is disclosed, any number falling within the range is specifically disclosed. Moreover, the indefinite articles “a” or “an”, as used in the claims, are defined herein to mean one or more than one of the element that it introduces.

What is claimed is:

1. A method for producing a propylene-based pre-polymer with improved performance in olefin polymerization, comprising:
preparing a bare catalyst (C) by contacting a solid catalyst component (C1) comprising magnesium, titanium and a halogen, and a vinyldisilane compound (C2); and
preparing the propylene-based pre-polymer (P) by contacting the bare catalyst (C) with propylene.

2. The method of claim 1, further comprising preparing the bare catalyst (C) by contacting the solid catalyst component (C1), the vinyldisilane compound (C2), and an organoaluminum compound (C3).

3. The method of claim 1, further comprising preparing the bare catalyst (C) by contacting the solid catalyst component (C1), the vinyldisilane compound (C2), and an organosilicon compound (C4) comprising one or more Si—O—C or Si—N—C bonds.

4. The method of claim 1, further comprising preparing the bare catalyst (C) by contacting the solid catalyst component (C1), the vinyldisilane compound (C2), an organoaluminum compound (C3), and an organosilicon compound (C4) comprising one or more Si—O—C or Si—N—C bonds.

5. The method of claim 1, wherein the vinyldisilane compound (C2) is represented by the formula:
(CH₂=CH—)ₘ(R¹)ₙ(R²O—)ₖSi—Si(—CH═CH₂)ₓ(R³)_{y}(—OR⁴)_{z}
wherein R¹, R², R³ and R⁴ are independently selected from a hydrocarbon group or a heteroatom-containing hydrocarbon group;
wherein 1≤m≤3, 0≤n≤2, 0≤k≤2, 0≤x≤3, 0≤y≤3, 0≤z≤3;
wherein m+n+k=3 and x+y+z=3;
wherein R¹ can be the same or different when n>1;
wherein R³ can be the same or different when y>1;
wherein R² can be the same or different when k>1; and
wherein R⁴ can be the same or different when z>1.

6. The method of claim 1, wherein the molar ratio of the vinyldisilane component (C2) to titanium in the solid catalyst component (C1) is in the range of about 0.01 to about 100.

7. The method of claim 1, wherein the molar ratio of the vinyldisilane component (C2) to titanium in the solid catalyst component (C1) is in the range of about 1.0 to about 10.

8. The method of claim 2, wherein the molar ratio of component (C3) to titanium in component (C1) is in the range of about 0 to about 1000.

9. The method of claim 2, wherein the molar ratio of component (C3) to titanium in component (C1) is in the range of about 1.0 to about 500.

10. The method of claim 3, wherein the molar ratio of organosilicon compound (C4) to titanium in component (C1) is in the range of about 0 to about 1000.

11. The method of claim 3, wherein the molar ratio of organosilicon compound (C4) to titanium in component (C1) is in the range of about 1.0 to about 100.

12. The method of claim 1, wherein the amount of the propylene-based pre-polymer is in the range of 1.0 g to 10 g, based on 1.0 g of the solid catalyst component (C1).

13. A method for producing a propylene-based pre-polymer with improved performance in olefin polymerization, comprising:
preparing a bare catalyst (C) by contacting a solid catalyst component (C1) comprising magnesium, titanium and a halogen, a vinyldisilane compound (C2), an organoaluminum compound (C3), and an organosilicon compound (C4) comprising one or more Si—O—C or Si—N—C bonds; and
preparing the propylene-based pre-polymer (P) by contacting the bare catalyst (C) with propylene.

14. A method for producing a propylene-based pre-polymer with improved performance in olefin polymerization, comprising:
preparing a bare catalyst (C) by contacting a solid catalyst component (C1) comprising magnesium, titanium and a halogen, and a vinyldisilane compound (C2); and
preparing the propylene-based pre-polymer (P) by contacting the bare catalyst (C) with propylene;
wherein the vinyldisilane compound (C2) is represented by the formula:
(CH₂=CH—)ₘ(R¹)ₙ(R²O—)ₖSi—Si(—CH═CH₂)ₓ(R³)_{y}(—OR⁴)_{z}
wherein R¹, R², R³ and R⁴ are independently selected from a hydrocarbon group or a heteroatom-containing hydrocarbon group;
wherein 1≤m≤3, 0≤n≤2, 0≤k≤2, 0≤x≤3, 0≤y≤3, 0≤z≤3;
wherein m+n+k=3 and x+y+z=3;
wherein R¹ can be the same or different when n>1;
wherein R³ can be the same or different when y>1;
wherein R² can be the same or different when k>1; and
wherein R⁴ can be the same or different when z>1.
